(19) United States
(12) Patent Application Publication
(10) Pub. No.: US 2004/0054938 A1
(43) Pub. Date: Mar. 18, 2004

(54) Controlling a computer system based on an environmental condition

(76) Inventors: Christian L. Belady, McKinney, TX (US); Shaun L. Harris, McKinney, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/422,294

(22) Filed: Apr. 24, 2003

Related U.S. Application Data
(60) Provisional application No. 60/411,626, filed on Sep. 17, 2002.

(51) Int. Cl. G06F 1/26

(52) U.S. Cl. 713/300

(57) ABSTRACT

A system that controls the operation of at least one component of a computer to compensate for an environmental condition, comprising means for detecting at least one environmental condition of the computer system, and means for reducing power consumption when at least one condition exceeds a predetermined value.

### CROSS-REFERENCE TO RELATED APPLICATIONS

This application claims priority benefit of U.S. Provisional Patent Application No. 60/411,626 entitled “THE ENVIRONMENTALLY ADAPTABLE SYSTEM,” filed Sep. 17, 2002, the disclosure of which is hereby incorporated herein by reference. This application is related to co-pending and commonly assigned U.S. patent application Ser. No. 10/246,024 entitled “INTEGRATED POWER CONVERTER MULTI-PROCESSOR MODULE,” filed Sep. 17, 2002, the disclosure of which is hereby incorporated herein by reference.

### FIELD OF THE INVENTION

This invention relates in general to computer systems, and in specific, to controlling a computing system based on an environmental condition.

### DESCRIPTION OF RELATED ART

A typical computer system is sensitive to its environment. For example, factors such a temperature and/or power quality will affect the performance and the availability of the computer system. Consequently, the subsystems that maintain their environment are typically designed to be robust in terms of capacity and redundancy. Thus, the computer system will be able to operate at a specified frequency in the worst case conditions.

Temperature is important to the performance of the computer system. If the ambient air temperature of the room housing the computer system is too high, the computer system will first typically provide a warning that it is ceasing function, and then it will typically perform a controlled shutdown so that no data is lost. However, if the computer board temperature exceeds a threshold, the computer system may shutdown immediately, thereby resulting in the loss of data.

To ensure proper ambient temperature, a cooling system with a capacity to remove heat that exceeds the computer system's peak heat generation is needed. A redundant cooling system is typically installed to act as a backup system in case of failure of the cooling system. To ensure proper board temperature, N+1 fans are typically provided to cool the boards, where N is the required number of fans, and the +1 is a redundant fan which protects against the failure of one of the N fans. Note that at higher altitudes, the air is less dense, and thus more cooling capacity is required for a system at a high altitude than a system at a lower altitude.

Power is also important to the performance of the computer system. If grid power is lost, the system will typically shutdown immediately, thereby resulting in the loss of data. To ensure proper power, the computer system typically uses two power grids to supply power. One grid may be supplying all of the power, while the other is in standby mode. When the first grid fails, the second begins supplying the power. In another arrangement each grid may be functioning and supplying a portion of the power. When one grid fails, the other grid increases its power output to supply the needs of the system.

Power is received by the system and is converted to voltages and/or currents usable by the system. If a power converter fails, which converts grid power to a power usable by the system, the system may be able to perform a controlled shutdown without the loss of data, or the system may shutdown with the loss of data. Loss of power may also adversely affect other systems, e.g. the cooling systems or the fans. To ensure proper power distribution to the computer system, N+1 converters are typically provided, where N is the required number of power converters, and the +1 is a redundant converter which protects against the failure of one of the N converters.

All of the above redundancy and over-capacity adds to the cost and complexity of the system. Some of the redundancy and over-capacity is synergistic, e.g. having redundant power converters increases the cooling needs, while increased cooling needs requires additional power. All of the redundancy and over-capacity also increase the cost of the infrastructure needed to support the computer system, e.g. a larger amount of space is needed for the computer system.

All of this redundancy and over-capacity is required because computer systems are required to operate in different ranges of temperature, power, altitudes, and other operating criteria. Systems are designed for the worst cases for all of the operating criteria. Consequently, some prior art systems will reduce system performance to ensure operations. For example, a computer system may be capable of operating at 552 MHz, and instead operate at 528 MHz so that less power is consumed which ensures operation at all environmental conditions.

### BRIEF SUMMARY OF THE INVENTION

One embodiment of the invention is a computer system comprising a component that performs a data operation, a sensor that detects an environmental condition of the computer system and forms an environmental signal, and a control module that receives the environmental signal and determines if the environmental condition exceeds a predetermined value, wherein the control module modifies an operation of the component from a first mode to a second mode when the environmental condition exceeds the predetermined value.

Another embodiment of the invention is a system that controls the operation of at least one component of a computer to compensate for an environmental condition, comprising means for detecting at least one environmental condition of the computer system, and means for reducing power consumption when at least one condition exceeds a predetermined value.

Another embodiment of the invention is a method for operating a computer system that comprises at least one component that performs a data operation, the method comprising detecting an environmental condition of the computer system, and changing an operation of the at least one component from one operating mode to another operating mode based on the environmental condition.

### BRIEF DESCRIPTION OF THE DRAWINGS

FIG. 1 depicts a gaussian curve with a failure point for prior art computer systems for an environmental condition.

FIGURE depicts a gaussian curve with a failure point for computer systems using an embodiment of the invention for an environmental condition.

FIG. 3 depicts an example of a system using an embodiment of the invention.

FIGS. 4A and 4B depict an example of the operation of an embodiment of the invention during a power virus event.

FIG. 5 depicts an example of a method of operation according to an embodiment of the invention.

### DETAILED DESCRIPTION

As previously discussed, systems are typically over-designed to handle peak or failure occurrences, which are rare events. Thus, typical systems, when operating under normal conditions, are operating below their peak capabilities. As a result, typical systems have a higher cost than they need. For example, as discussed above, typical computer systems include redundant components, e.g. fans and power converters, but the failure of one or more of these components is a relatively rare event. However, this redundancy adds to the cost of the system, in terms of cost of the components, cost of supporting the components (e.g. power and cooling), and cost of housing the components.

Embodiments of the invention allow a computer system to be built for peak performance during normal operating conditions. Consequently, the over-capacity and/or redundancy may be eliminated from systems using the embodiments of the invention. Embodiments of the invention preferably use one or more sensors that are located proximate to the computer system and measure one or more of power conditions, ambient temperature, board temperature, altitude, and airflow into the computer system. When one or more sensors indicate that their measured criteria have exceeded a predetermined threshold, the computer system would preferably be placed into a low-power-usage mode. In the low-power-usage mode, the computer system would preferably operate at a reduced performance level, and thereby require less power and generate less heat. Note that in the low-power-usage mode, processing continues and no data are lost. When the measured criteria is below the predetermined threshold, the computer system would then be preferably placed in a normal mode of operation. Note that the predetermined threshold is preferably below a system shutdown threshold, thus the computer system may continue to operate at the reduced performance level until the measured criteria returns to normal.

One or more of several situations may cause the measured criteria to exceed the predetermined threshold. For example, a cooling fan that provides airflow across a system board may fail. This may cause the board temperature to rise and/or a drop in the airflow across the system board. Other situations could be a clogged filter, a cooling system failure, a power converter failure, a power grid failure, low grid line voltage, poor design, etc. Another situation could be that an object has been placed so as to block airflow to at least a portion of the computer system.

Embodiments of the invention preferably place the computer system at the reduced performance level by changing the operation of the computer system. For example, the processors of the computer system may be switched from a multiple issue mode, where multiple instructions are executed in parallel, to a single issue mode, where only a single instruction is executed at-a-time. In other words, embodiments of the invention allow a computer system to operate with reduced throughput, but without the loss of data. As another example, the clock frequency of the computer system may be reduced so that the system operates at a slower pace. This example may be complex, particularly for larger systems that have a plurality of clock signal generators. Each clock generator would have to stay synchronous with the other clock generators during the transition, which may be difficult if the transition requires more than one clock cycle.

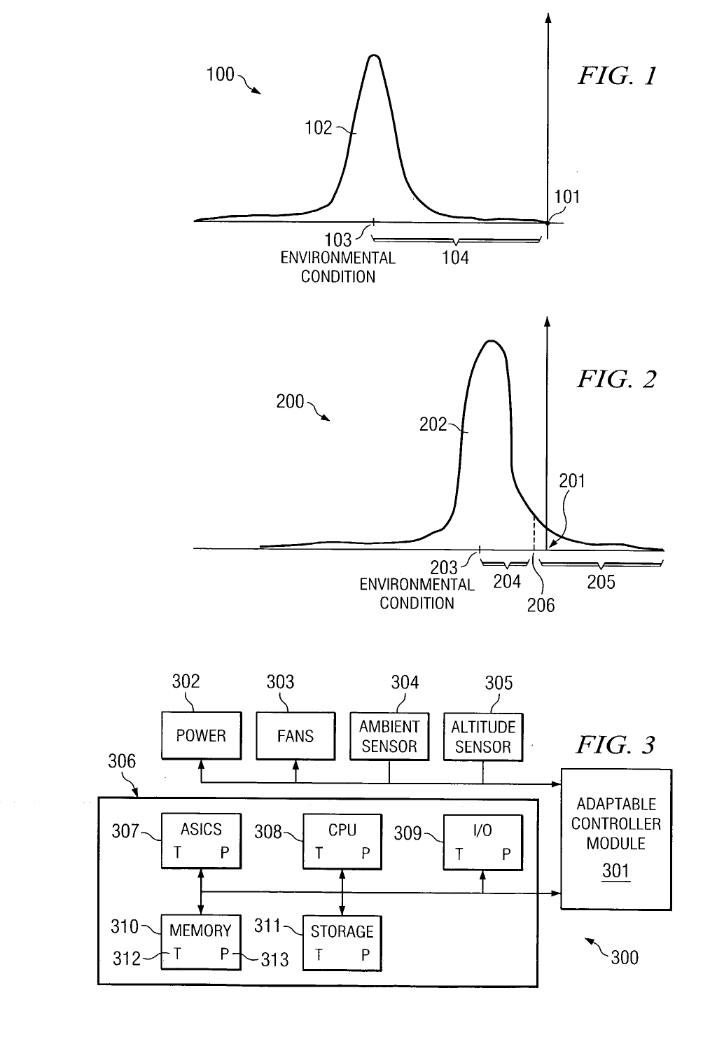

FIG. 1 depicts a gaussian distribution 100 for a plurality of computer systems. The height of the curve 100 represents a number of computer systems that are operating a particular level of an environmental condition, which is the horizontal axis. Most computer systems operate in the central region 102 around environmental conditions 103. However, some computer systems operate at the extremes, e.g. point 101. For example, if the environmental condition is temperature, then most computer systems operate in a range near room temperatures. However, some computer systems may be operating at much colder or hotter temperature. Each computer system is designed to operate until environmental condition 101 is reached. Such a condition may be multiple standard deviations from point 103, e.g. nine standard deviations. For example, the computer system may be typically built to operate at high altitudes (e.g. 10,000 feet) or may be built to operate at high temperatures (e.g. 110° F.). The computer system also may be designed to be operated in different types of data center facilities, e.g. a Tier 4 data center is well equipped with good cooling and power distributions, while another facility is not well equipped. The computer system is designed to be operated in both. Also, the redundancies and over-capacities discussed previously, e.g. N+1 fans, N+1 power converters, etc., may be built into the computer system. Note that the redundancies and over-capacities also need to be taken into account in the design of the infrastructure. In other words, there needs to be sufficient floor space, cooling, and power for the redundancies and over-capacities.

This results in expensive computer systems. Thus, the average computer solution includes the cost and complexity of the most extreme computer solution. The distance 104 between point 101 and 103 represents the under-utilization of the system. In other words, in most operations the system will operate around point 103, but the system is capable of operating up to point 101. In considering the sale of a plurality of these systems to a plurality of customers, perhaps 1 in 100 customers (or fewer) will operate the system near the failure point 101. Thus, for the remaining customers, their systems are either operating well below their peak capacity and/or comprise much more redundancy than is needed.

FIG. 2 depicts a gaussian distribution 200 for a plurality of computer systems operating according to an embodiment of the invention. Most computer systems operate in the central region 202 around environmental conditions 203. Each computer system is designed to operate until environmental condition 201 is reached. Note that as compared with FIG. 1, the point 203 is located much closer to failure point 201, for example, less than three standard deviations. Thus, the distance 204 is much less than 104. Thus, each computer system of FIG. 2 is operating closer to it peak capabilities, than the systems of FIG. 1.

Note that the curve 200 may be achieved by increasing the performance of the systems of FIG. 1, e.g. increasing processor speed or other functionality of each system so that more heat is generated and/or more power is needed. In other words, the failure point 201 is the same as the failure point 101, and the typical operating region 202 has moved closer to the failure point 201. Alternatively, the curve 200 may be achieved by reducing the redundancy and/or over-capacity, such that the system has reduced environmental capacity, e.g. removing (or not installing) N+1 redundancy. In other words, the typical operating region has remained the same between FIGS. 1 and 2, and the failure point 201 has moved closer to the operating region 202. Alternatively, the curve 200 may be achieved by both increasing performance and reducing the redundancy and/or over-capacity.

As described earlier, embodiments of the invention prevent failure of the computer system by placing the computer system in mode (the reduced operation mode) with a reduced performance level when one or more criteria of the environmental conditions exceeds a predetermined value 206. The preferred location of the predetermined criteria 206 is between point 203 and point 201. The preferred location is to be as close to point 201 as possible, and still prevent the computer system from failing. Thus, distance 204 is preferably a design consideration based on how often one or more customers will accept the reduced operation mode. For example, a system having nine standard deviations of distance 104 may be reduced to two standard deviations 204, however having 0.25 standard deviations may be unacceptable to the one or more customers. Note that computer systems would not be operating in region 205. According to embodiments of the invention, when threshold 206 is reached by a computer system, the computer system (or a component thereof) will be shifted into the low power mode, which will prevent the computer system from reaching failure point 201.

FIG. 3 depicts an example of a system 300 using an embodiment of the invention. System 300 preferably includes a plurality of sensors. For example, a sensor on power subsystem 302 provides an indication of the current and/or voltage (e.g. a current and/or a voltage sensor) being supplied to the system 300, a sensor on fan(s) 303 reports on the status of one or more cooling fans of the system, an ambient sensor reports on ambient environmental conditions (e.g. temperature, humidity, etc.), and/or altitude sensor 305 reports the air pressure being exerted on the system. Other sensors may indicate that status of an air conditioning system. Note that some current computer chips include on-die temperature sensors that could be used by an embodiment of the invention.

The sensors preferably report to the adaptable controller module 301. The module 301 also preferably receives status signals from sensors mounted on one more components with in the computer system 306. For example, a temperature sensor 312 and/or power sensor 313 may be mounted in one or more components, e.g. a CPU (central processing unit) board 308, an ASICS (application specific integrated circuits) board 307, an I/O (input/output) board 309, a memory board 310, and/or a storage device 311. Based on the sensors, the module 301 can compare the received power versus the power being consumed, as well as the heat being generated by the system 300, and the heat removal capability of the system 300. Thus, the module can determine when an environmental threshold is exceeded.

The adaptable control module 301 can also preferably control the operations of the systems 300. As shown in FIG. 3, the module 301 is connected to one or more of the power subsystem 302, the fans 303, the ASICS 307, the CPU 308, the I/O 309, the memory 310 and the storage 311. When the module 301 detects that a threshold has been exceeded, the module may then act to reduce (or increase) the performance of one or more of the components. For example, if the module detects an ambient overheat condition, the module may increase the fan 303 operation, may increase the air conditioning system (not shown) operation, and/or decrease the performance of the CPU 308. The module 301 may reduce the power consumption of one component (e.g. ASICS 307, CPU 308, I/O 309, memory 310, storage 311, fans 303), all components, or a portion of the components. The module 301 may also reduce the power consumption of a component or a portion of a component that is exceeding an environmental condition, e.g. temperature and/or power. The module 301 may issue a command to a component such that the component operates in a manner that reduces the power consumed by it. The module may reduce the power supplied to a component. The module may both issue a command and reduce the power supplied to it. Also note that the module 301 is shown controlling one computer system 306, but may control a plurality of systems. Further note that the module 301 is shown controlling one system 300, but may control a plurality of systems.

The module may place one or more components in a reduced operation mode, which would consume less power. An example of this operation is described in related U.S. patent application Ser. No. 10/246,024 entitled “INTEGRATED POWER CONVERTER MULTI-PROCESSOR MODULE,” filed on Sep. 17, 2002, which is hereby incorporated herein by reference. For example, a CPU may be changed from a multiple issue mode to a single issue mode. Thus, CPU would only execute one instruction at a time, instead of executing multiple instructions in parallel. Since less resources are being used, the power required to operate the CPU is reduced. Also, the heat generated by the CPU would be reduced. Thus, the performance of the CPU is degraded, but no data are lost. The other components, e.g. the ASICs 307, the I/O 309, the memory 310, and the storage 311, may be similarly manipulated. Note that heat and/or power reduction on other components (or the entire system) may be reduced by reducing the operations of the CPU. For example, if an environmental condition is exceeded by a memory device 310, then reducing the operations of the processor may also reduce the heat produced/power required by the memory device. When the level of the environmental condition falls below the threshold or predetermined level, the module 301 would then return the component and/or system back to the normal operating performance level.

Note that operating with one limit or threshold level may cause the system to oscillate between the normal mode and the low power mode, if the system is operating close to the limit. The use of more than one trigger level would form a hysteresis loop that would reduce the oscillations. For example, FIG. 5 depicts an embodiment of the invention 500 that uses environmental limits to change the operation of the systems and/or components within the system. In block 501 the environmental condition is detected, preferably by a sensor. The level of the condition is preferably provided to the module 301, which determines whether the level of the condition exceeds an upper limit in block 502. If so, then the module causes the component or system to change its operation to reduce power consumption, as shown in block 503. In block 504, the module also determines whether level of the condition is below a lower limit. If so, then the module causes the component or system to change its operation to increase power consumption, as shown in block 505. This may be accomplished, for example, by increasing the speed of the processor or increasing the number of instructions issued per cycle. Note that block 504 may occur before block 502. If both blocks 502 and 504 are noes, then the embodiment of the invention maintains the current level of operation of the component or system and thus maintains the current power consumption.

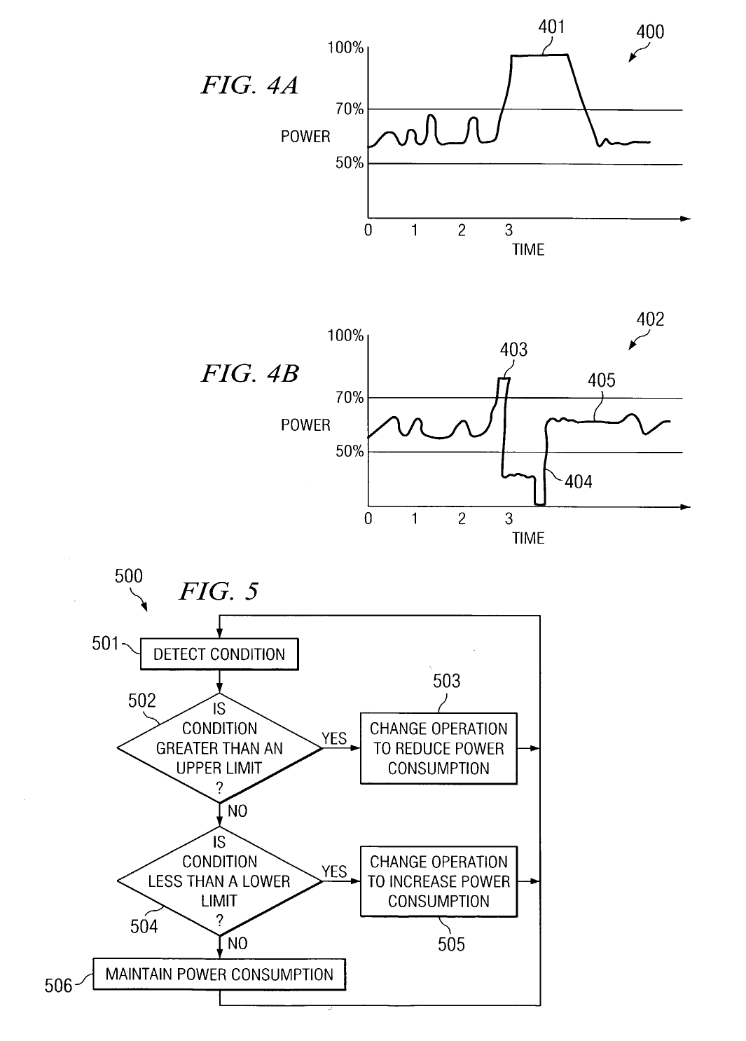

An example of the operation of the module 301 is shown in FIGS. 4A and 4B. FIG. 4A depicts an example of an event known as a power virus 401, whereby a stream of instructions causes the power requirements of the system to peak at 100%. The power virus 401 may cause this peak usage to occur for some time. FIG. 4B depicts the operation of the module 301 during a power virus event. After detection of the power virus 403, the module 301 places the CPU in the reduced operation mode 404. As shown in FIG. 4B, the power requirement drops to a reduced level. Eventually, the virus ceases, and the module returns the CPU to a normal operations mode 405.

The module 301 has been discussed in terms of reducing the system performance when adverse environmental conditions have been detected. However, the module may also increase system performance when favorable environmental conditions are detected.

What is claimed is:

1. A computer system comprising:
a component that performs a data operation;
a sensor that detects an environmental condition of the computer system and forms an environmental signal; and
a control module that receives the environmental signal and determines if the environmental condition exceeds a predetermined value;
wherein the control module modifies an operation of the component from a first mode to a second mode when the environmental condition exceeds the predetermined value.

2. The computer system of claim 1, wherein the first mode is a normal operating mode, and the second mode is a low power consumption mode.

3. The computer system of claim 1, wherein the first mode is a normal operating clock speed, and the second mode is a lower operating clock speed.

4. The computer system of claim 1, wherein the component is a processor, and the first mode is a multiple instruction issue mode and the second mode is a single instruction issue mode.

5. The computer system of claim 1, wherein the component maintains data integrity during operation in the second mode.

6. The computer system of claim 1, wherein the environmental condition is selected from the group consisting of:
a temperature, a room temperature, a board temperature, a component temperature, a power condition, a power grid condition, a power converter condition, a component power condition, and an air pressure.

7. The computer system of claim 1, wherein the environmental condition is associated with the component.

8. The computer system of claim 1, wherein the environmental condition is associated with another component of the computer system.

9. The computer system of claim 8, wherein the another component is selected from the group consisting of:
a power grid, a power converter, a fan, a computer board, a processor, an ASIC, an I/O device, a memory device, and a storage device.

10. The computer system of claim 1, wherein the control module returns the component to the first mode when the environmental condition is below the predetermined value.

11. The computer system of claim 1, wherein the control module returns the component to the first mode when the environmental condition is below another predetermined value, wherein the another predetermined value is below the predetermined value.

12. The computer system of claim 1, wherein the predetermined value is selected to be within a three sigma of a failure point of the computer system.

13. A system that controls the operation of at least one component of a computer to compensate for an environmental condition, comprising:
means for detecting at least one environmental condition of the computer system; and
means for reducing power consumption when at least one condition exceeds a predetermined value.

14. The system of claim 13, wherein the means for reducing power consumption increases power consumption when the environmental condition is below the predetermined value.

15. The system of claim 13, wherein the means for reducing power consumption increases power consumption when the environmental condition is below another predetermined value, wherein the another predetermined value is below the predetermined value.

16. The system of claim 13, wherein the component is a processor, and the means for reducing power consumption changes the processor from a multiple instruction issue mode to a single instruction issue mode.

17. The computer system of claim 13, wherein the component maintains data integrity during operation in a reduced power consumption mode.

18. A method for operating a computer system that comprises at least one component that performs a data operation, the method comprising:
detecting an environmental condition of the computer system; and
changing an operation of the at least one component from one operating mode to another operating mode based on the environmental condition.

19. The method of claim 18, further comprising:
determining that that environmental condition of the computer system exceeds a predetermined value;
wherein the changing an operation causes a reduction in the power consumption of the at least one component.

20. The method of claim 18, further comprising:
determining that that environmental condition of the computer system is below a predetermined value;
wherein the changing an operation causes an increase in the power consumption of the at least one component.
